(19) United States
(12) Patent Application Publication
(10) Pub. No.: US 2025/0274240 A1
(43) Pub. Date: Aug. 28, 2025

(54) METHODS FOR UPLINK RESOURCE MAPPING

(71) Applicant: Apple Inc., Cupertino, CA (US)

(72) Inventors: Yushu Zhang, Beijing (CN); Qiming Li, Beijing (CN); Chunxuan Ye, San Diego, CA (US); Seyed Ali Akbar Fakoorian, San Diego, CA (US); Yang Tang, San Jose, CA (US); Chunhai Yao, Beijing (CN); Wei Zeng, Saratoga, CA (US); Haitong Sun, Cupertino, CA (US); Dawei Zhang, Saratoga, CA (US); Jie Cui, San Jose, CA (US)

(21) Appl. No.: 18/858,210

(22) PCT Filed: Apr. 21, 2022
(86) PCT No.: PCT/CN2022/088190

§ 371 Date: Oct. 18, 2024

(51) Int. Cl. H04L 5/00; H04W 72/0446; H04W 72/1268

(52) U.S. Cl. CPC H04L 5/0051; H04W 72/0446; H04W 72/1268

(57) ABSTRACT

A user equipment (UE) includes a transceiver and a processor. The processor is configured to determine an uplink transmission is intended to be transmitted, via the transceiver, in a slot in which a downlink transmission is scheduled; identify a potential synchronization error when the uplink transmission overlaps, in time and in the slot, any of: a set of one or more symbols in which the downlink transmission is scheduled, X symbols before the set of one or more symbols in which the downlink transmission is scheduled, or Y symbols after the set of one or more symbols in which the downlink transmission is scheduled; and drop the uplink transmission upon identifying the potential synchronization error, and otherwise multiplex transmission of the uplink transmission with reception of the downlink transmission in the slot.

### TECHNICAL FIELD

This application relates generally to wireless communication systems, including methods and implementations for uplink (UL) resource mapping and, in some cases, UL resource mapping for multiple transmission and reception point (multi-TRP) operation and/or inter-cell mobility operation of a user equipment (UE).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIGS. 2A, 2B, 3A, and 3B show various examples for transmitting aperiodic channel state information (CSI) over a physical uplink shared channel (PUSCH) with repetition.

FIG. 4A shows an example of PUSCH repetition dropping.

FIG. 4B shows an example of PUSCH repetition multiplexing.

FIG. 5 shows an example method of wireless communication by a UE, which method may be used to perform CSI to PUSCH resource mapping such that soft combining (e.g., chase combining) can be performed by a base station for CSI repetition decoding.

FIG. 6 shows an example method of wireless communication by a UE, which method may be used to perform UL resource mapping that, for multi-TRP and/or inter-cell mobility operation of the UE, accounts for synchronization errors between transmission and reception points (TRPs)/cells.

FIG. 7A shows an example of PUSCH repetition dropping, in accord with some of the operations shown in FIG. 6.

FIG. 7B shows an example of PUSCH repetition multiplexing, in accord with some of the operations shown in FIG. 6.

FIG. 8 shows an example of PUSCH repetition shifting.

FIG. 9 shows an example method of wireless communication by a base station, which method may be used to perform UL resource mapping that, for multi-TRP and/or inter-cell mobility operation of the UE, accounts for synchronization errors between TRPs/cells.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

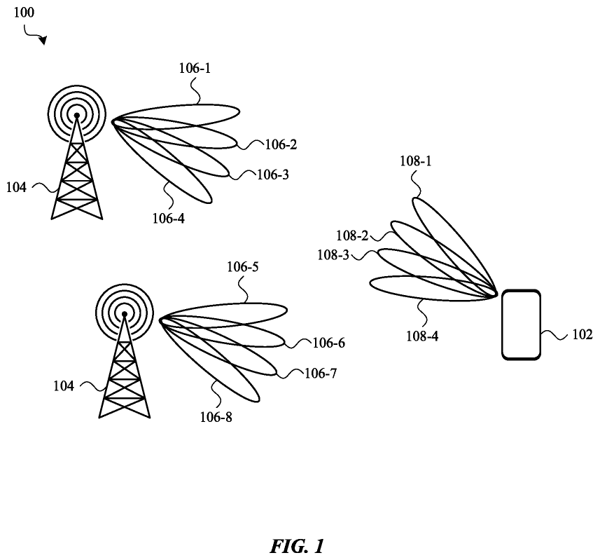

FIG. 1 shows an example wireless communication system 100, according to embodiments described herein. The wireless communication system 100 may operate in accord with the LTE system standards, 5G or NR system standards, or other standards provided by 3GPP technical specifications.

As shown in FIG. 1, the wireless communication system 100 may include a UE 102 and one or more base stations 104 (e.g., eNBs or gNBs). The UE 102 may communicate with one or both of the base stations 104, sequentially (e.g., in a handover scenario) or simultaneously (e.g., in a multiple transmission and reception point (multi-TRP) scenario). The UE 102 may also communicate with other base stations 104. In some embodiments, the UE 102 may be one of multiple UEs that simultaneously or contemporaneously communicate with one or both of the base stations 104 (or other base stations). In some embodiments, one or both of the base stations 104, alone or in combination with one or more other base stations, may form part or all of a cellular RAN.

In some cases, one or both of the base stations 104 may transmit one or more DL channels to the UE 102. The DL channels may be transmitted on one or multiple DL beams 106 (e.g., DL beams 106-1, 106-2, 106-3, and/or 106-4, or DL beams 106-5, 106-6, 106-7, and/or 106-8). Similarly, the UE 102 may transmit one or more UL channels to the base station 104. The UL channels may be transmitted on one or multiple UL beams 108 (e.g., UL beam 108-1, 108-2, 108-3, and/or 108-4).

In some cases, the UE 102 and a base station 104 may communicate on a single CC. In other cases, the UE 102 and the base station 104 may communicate on multiple CCs in a carrier aggregation (CA) mode. The UE 102 may also communicate with more than one base station 104 simultaneously over a set of multiple CCs.

In 3GPP Release 17 (Rel-17), a base station can configure a UE to transmit PUSCH with N repetitions on M beams. M is typically equal to 1 or 2, and N is typically 2 or 4 thonoh each variable can assume other values. The values of M and N may be the same or different. The N repetitions of PUSCH are multiplexed in a time division multiplexing (TDM) manner. The M beams can be mapped to the N repetitions in a cyclic or sequential manner.

Channel state information (CSI) may be reported in PUSCH with repetition using one of two schemes. In a first scheme (Scheme 1), CSI is only reported in a first PUSCH repetition, regardless of the number of beams used to transmit the PUSCH repetitions. In a second scheme (Scheme 2), CSI is reported in the first PUSCH repetition for each beam. Scheme 1 is the default scheme. Scheme 2 can be enabled by a radio resource control (RRC) parameter and can be used to report aperiodic CSI or semi-persistent CSI, but only when the time domain duration for both PUSCH repetitions is the same and the CSI is not multiplexed with other UL control information in the PUSCH repetitions containing CSI. The CSI content in each repetition is the same. For the report of semi-persistent CSI over PUSCH with repetition, N is always equal to 2.

One motivation for the above conditions for Scheme 2 is to ensure that different repetitions of CSI have the same coding rate. This is because CSI is coded by polar code. Polar coding supports chase combining well, but does not support incremental redundancy well. To support chase combining, the coded CSI bits have to be coded with the same number of elements, so that chase combining can be used to decode the CSI.

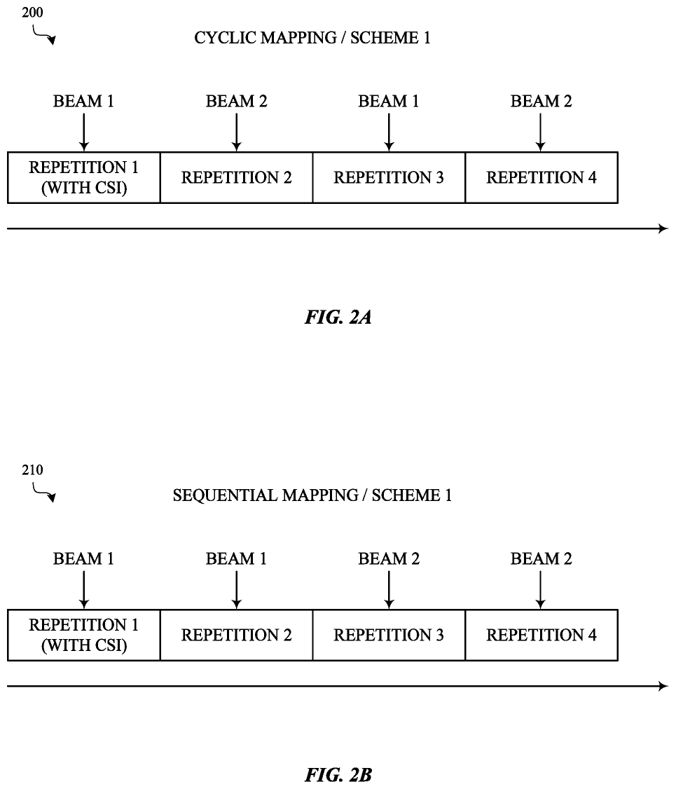

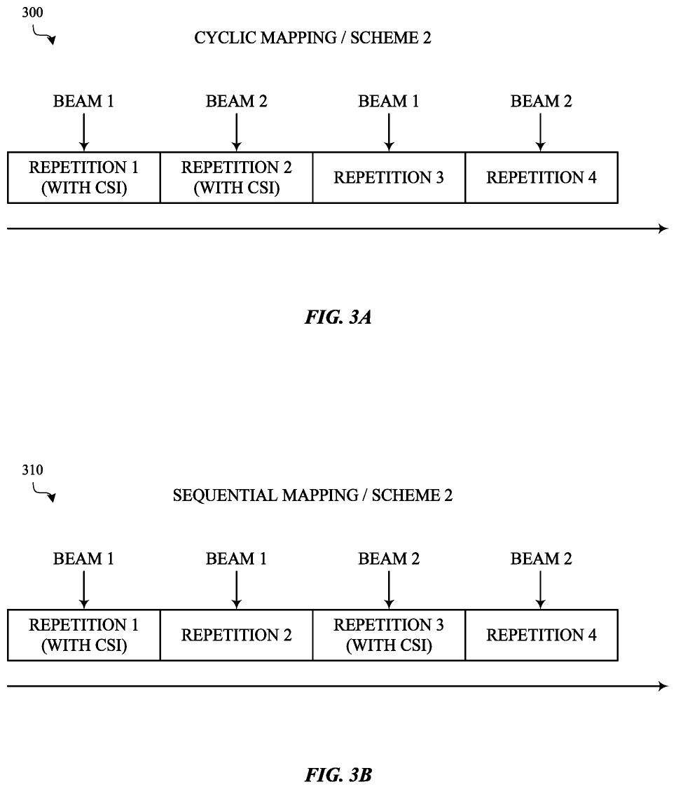

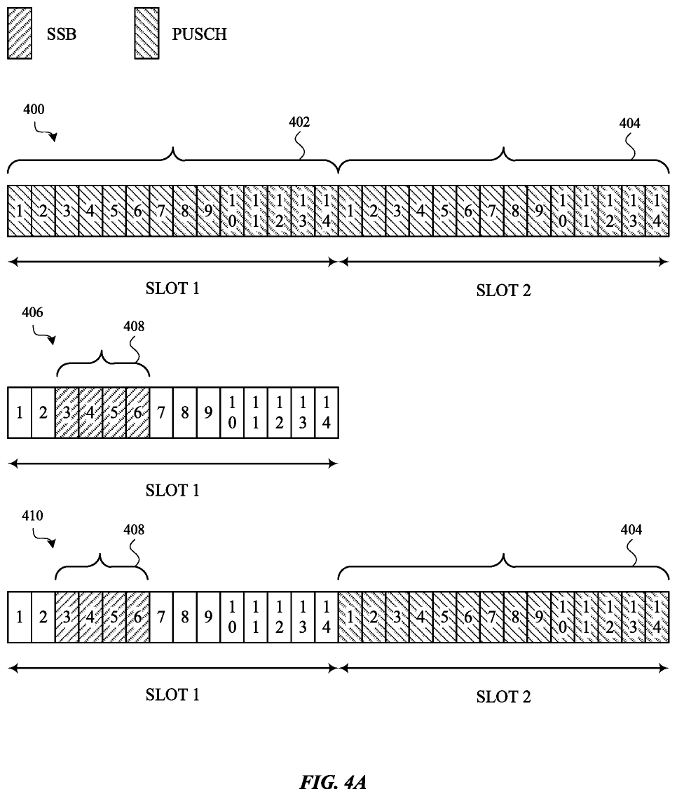

FIGS. 2A, 2B, 3A, and 3B show various examples for transmitting aperiodic CSI over PUSCH with repetition. FIGS. 2A and 2B show examples for transmitting CSI under Scheme 1, and FIGS. 3A and 3B show examples for transmitting CSI under Scheme 2.

As shown in FIG. 2A, a UE may transmit PUSCH on two beams (Beam 1 and Beam 2) mapped to four PUSCH repetitions in accord with a cyclic beam mapping 200. Thus, Repetition 1 and Repetition 3 are transmitted on Beam 1, and Repetition 2 and Repetition 4 are transmitted on Beam 2. In accord with Scheme 1 for transmitting CSI, CSI may only be transmitted in Repetition 1. As shown in FIG. 2B, a UE may transmit PUSCH on two beams (Beam 1 and Beam 2) mapped to four PUSCH repetitions in accord with a sequential beam mapping 210. Thus, Repetition 1 and Repetition 2 are transmitted on Beam 1, and Repetition 3 and Repetition 4 are transmitted on Beam 2. In accord with Scheme 1 for transmitting CSI, CSI may only be transmitted in Repetition 1.

As shown in FIG. 3A, a UE may transmit PUSCH on two beams (Beam 1 and Beam 2) mapped to four PUSCH repetitions in accord with a cyclic beam mapping 300. Thus, Repetition 1 and Repetition 3 are transmitted on Beam 1, and Repetition 2 and Repetition 4 are transmitted on Beam 2. In accord with Scheme 2 for transmitting CSI, CSI may be transmitted in Repetition 1 and Repetition 2, which are the first repetitions using each of Beams 1 and 2 respectively. As shown in FIG. 3B, a UE may transmit PUSCH on two beams (Beam 1 and Beam 2) mapped to four PUSCH repetitions in accord with a sequential beam mapping 310. Thus, Repetition 1 and Repetition 2 are transmitted on Beam 1, and Repetition 3 and Repetition 4 are transmitted on Beam 2. In accord with Scheme 2 for transmitting CSI, CSI may be transmitted in Repetition 1 and Repetition 3, which are the first repetitions using each of Beams 1 and 2 respectively.

To support soft combining based decoding for two CSI repetitions, only chase combining can be used. For chase combining, the number of coded CSI bits for two CSI repetitions should be the same. The coded CSI bits are calculated using the following formula, as described in 3GPP technical specification (TS) 38.212, § 6.3.2.4.1.2:

$${Q}_{CSI - 1}^{′} = \{ ⌈ \frac{( {O}_{CSI - 1} + {L}_{CSI - 1} ) \cdot {β}_{offset}^{PUSCH} \cdot {\sum }_{l = 0}^{{N}_{sym , {all}^{- 1}}^{PUSCH}} {M}_{SC}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{sym , {all}^{- 1}}^{PUSCH}} {M}_{SC}^{UCI} ( l ) ⌉ - {Q}_{ACK / CG - UCI}^{′} \}$$

where M_{SC}^{UCI} indicates the number of subcarriers allocated for PUSCH, excluding the number of subcarriers used for phase tracking reference signals (PT-RS). Other parameters included in the above equation are defined in 3GPP TS 38.212, § 6.3.2.4.1.2.

The number of coded CSI bits is determined by the number of elements allocated for transmission of the CSI. The number of elements depends on the number of subcarriers allocated for PUSCH, excluding the subcarriers used for PT-RS (i.e., M_{SC}^{UCI}).

A UE may transmit different numbers of PT-RS ports for different PUSCH beams. The number of PT-RS ports is dynamically determined by the precoder used for PUSCH, which may vary for different PUSCH beams. For example, a UE may transmit a one-port PT-RS transmission in a repetition transmitted using a first beam, and may transmit a two-port PT-RS transmission in a repetition transmitted using a second beam. In this case, the number of subcarriers used for PT-RS in different PUSCH repetitions may differ, leading to a different number of coded CSI bits in different repetitions. If different repetitions of CSI have different numbers of coded bits, chase combining cannot be used to decode the CSI repetitions.

For time division duplex (TDD) operation, a slot can be denoted as “flexible,” meaning it can be used for either UL transmission, DL transmission, or both UL and DL transmissions in different symbols. If a UE intends to transmit a PUSCH repetition in a flexible slot, but the PUSCH repetition overlaps a synchronization signal block (SSB) of the UE's serving cell in the time domain, the UE should drop (i.e., not transmit) the PUSCH repetition. When the UE is configured with an active transmission configuration indicator (TCI) state that relies on a neighbor cell for inter-cell multi-TRP or inter-cell mobility operations, the UE should drop a PUSCH repetition if it overlaps an SSB of the neighbor cell as well. In addition, a base station is not allowed to schedule an UL transmission on SSB symbols that are to be measured, or on one data symbol before or after a set of consecutive SSB symbols that are to be measured. This latter condition includes an SSB used for any of Layer 1 (L1) reference signal received power (RSRP) (L1-RSRP) measurement, L1 signal to interference noise ratio (L1-SINR) measurement, beam failure detection (BFD), candidate beam detection (CBD), radio link monitoring (RLM), or pathloss measurement.

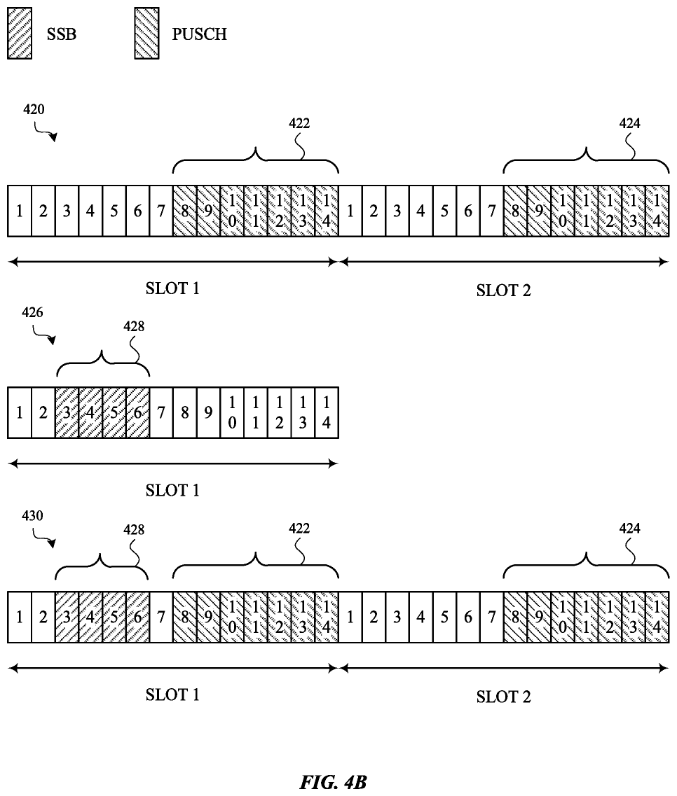

FIG. 4A shows an example of PUSCH repetition dropping, and FIG. 4B shows an example of PUSCH repetition multiplexing. In the examples shown in FIGS. 4A and 4B, Slot 1 is a flexible slot, and Slot 2 is an UL slot.

In the example of FIG. 4A, a UE may intend to transmit a first PUSCH repetition 402 across every symbol of Slot 1, and transmit a second PUSCH repetition 404 across every symbol of Slot 2, as shown in timeline 400. However, a base station may schedule an SSB transmission 408 during symbols 3-6 of Slot 1, as shown in timeline 406. Because the first PUSCH repetition 402 overlaps the SSB transmission 408, the UE may drop the first PUSCH repetition 402 and only transmit the second PUSCH repetition 404, as shown in timeline 410.

In the example of FIG. 4B, a UE may intend to transmit a first PUSCH repetition 422 across symbols 8-14 of Slot 1, and transmit a second PUSCH repetition 424 across symbols 8-14 of Slot 2, as shown in timeline 420. However, a base station may schedule an SSB transmission 428 during symbols 3-6 of Slot 1, as shown in timeline 426. Because the first PUSCH repetition 422 does not overlap the SSB transmission 428 and begins at least one symbol after the SSB transmission 428, the UE may multiplex transmission of the first PUSCH repetition 422 with the SSB transmission 428 in Slot 1, and may also transmit the second PUSCH repetition 424 in Slot 2, as shown in timeline 430.

Given the above context, one issue is how to perform CSI to PUSCH resource mapping to ensure that soft combining (e.g., chase combining) can be performed by a base station for CSI repetition decoding.

Another issue is that, for multi-TRP and/or inter-cell mobility operation of a UE, there may be a synchronization error between TRPs/cells, and the timings to receive and transmit signals between the UE and different TRPs/cells can be different. Thus, UL transmissions to different TRPs/cells may overlap (or not overlap) the symbols of a particular SSB transmission (or adjacent buffer symbols) in different ways.

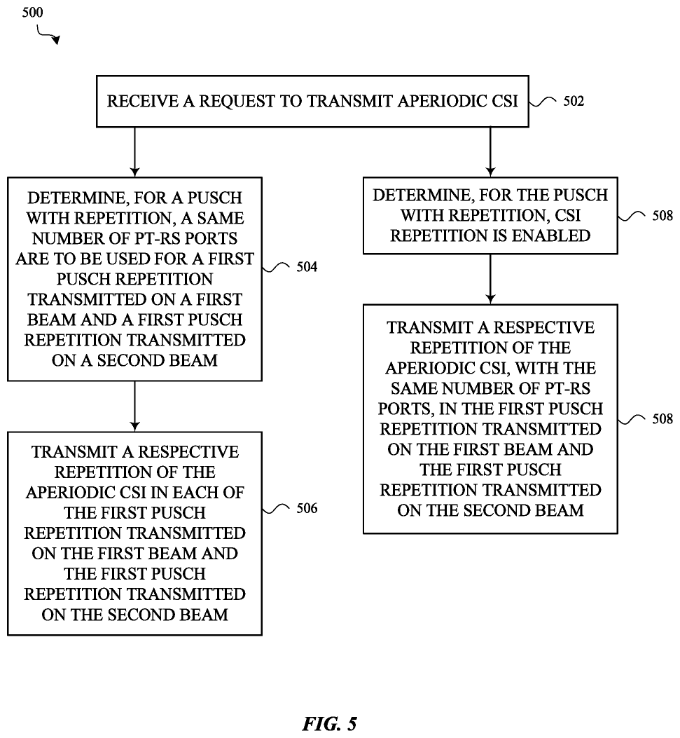

FIG. 5 shows an example method 500 of wireless communication by a UE, which method 500 may be used to perform CSI to PUSCH resource mapping such that soft combining (e.g., chase combining) can be performed by a base station for CSI repetition decoding. The method 500 may be performed by a processor of the UE, and transmissions and receptions initiated by the processor may be made using a transceiver of the UE.

At 502, the method 500 may include receiving a request to transmit aperiodic CSI. The request may be received from a base station.

After the operation(s) at 502, the method 500 may include the operation(s) at one of 504/506 or 508/510.

At 504, the method 500 may include determining, for a PUSCH with repetition, a same number of PT-RS ports are to be used for a first PUSCH repetition transmitted on a first beam and a first PUSCH repetition transmitted on a second beam. At 506, and in response to determining the same number of PT-RS ports are to be used for the first PUSCH repetition transmitted on the first beam and the first PUSCH repetition transmitted on the second beam, the method 500 may include transmitting a respective repetition of the aperiodic CSI in each of the first PUSCH repetition transmitted on the first beam and the first PUSCH repetition transmitted on the second beam.

At 508, the method 500 may include determining, for the PUSCH with repetition, CSI repetition is enabled. At 510, and in response to determining CSI repetition is enabled, transmitting a respective repetition of the aperiodic CSI, with the same number of PT-RS ports, in the first PUSCH repetition transmitted on the first beam and the first PUSCH repetition transmitted on the second beam.

No PT-RS transmission (i.e., use of zero PT-RS ports) can be considered a special case of the operation(s) at 504/506 and 508/510.

In the operations at blocks 504 and 506, CSI repetitions are only enabled when the number of PT-RS ports for two PUSCH repetitions are the same. If the numbers of PT-RS ports are different, the UE may only report CSI in one PUSCH repetition (e.g., the earliest PUSCH repetition).

In the operations at blocks 508 and 510, the numbers of PT-RS ports for the PUSCH repetitions in which CSI is reported are forced to be the same. In some of these embodiments, the method 500 may include determining the same number of PT-RS ports based on the number of PT-RS ports to be used for one PUSCH repetition (e.g., the earliest PUSCH repetition). For example, the method 500 may include identifying the same number of PT-RS ports as a first number of PT-RS ports to be used in the first PUSCH repetition transmitted using the first beam; and harmonizing, with the first number of PT-RS ports, a second number of PT-RS ports to be used in the first PUSCH repetition transmitted using the second beam. In some cases, the first PUSCH repetition transmitted using the first beam may be the earliest PUSCH repetition in the PUSCH with repetitions.

In other embodiments in which the numbers of PT-RS ports for the PUSCH repetitions in which CSI is reported are forced to be the same, the method 500 may include determining the same number of PT-RS ports based on initial numbers of PT-RS ports that are to be used in each PUSCH repetition in which CSI is reported. For example, the method 500 may include determining the same number of PT-RS ports based on 1) a first initial number of PT-RS ports to be used in the first PUSCH repetition transmitted using the first beam and 2) a second initial number of PT-RS ports to be used in the first PUSCH repetition transmitted using the second beam. In some cases, this may involve determining a maximum or a minimum number of PT-RS ports (i.e., a maximum or a minimum of 1) the first initial number of PT-RS ports to be used in the first PUSCH repetition transmitted using the first beam and 2) the second initial number of PT-RS ports to be used in the first PUSCH repetition transmitted using the second beam).

In a third alternative following the operation(s) at 502 (not shown), the method 500 may include determining, for the PUSCH with repetition, that PT-RS transmission is enabled and, upon determining that PT-RS transmission is enabled, only reporting CSI in one PUSCH repetition (e.g., the earliest PUSCH repetition).

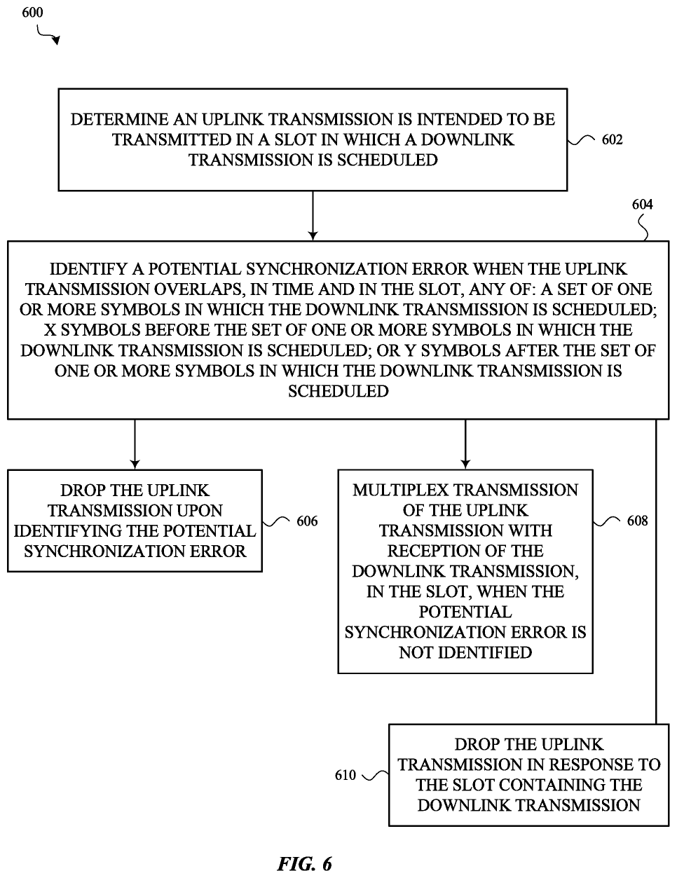

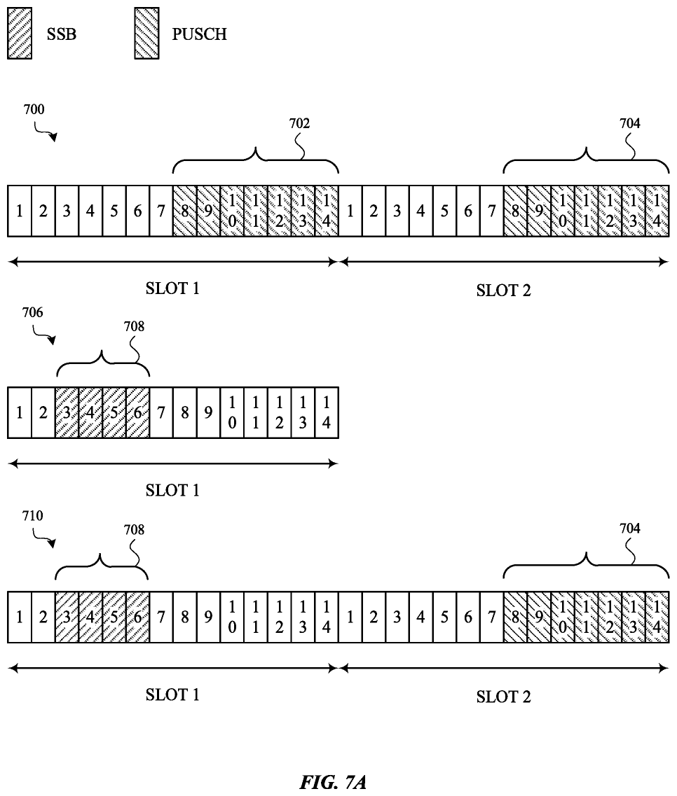

FIG. 6 shows an example method 600 of wireless communication by a UE, which method 600 may be used to perform UL resource mapping that, for multi-TRP and/or inter-cell mobility operation of the UE, accounts for synchronization errors between TRPs/cells. The method 600 may be performed by a processor of the UE, and transmissions and receptions initiated by the processor may be made using a transceiver of the UE.

At 602, the method 600 may include determining an uplink transmission is intended to be transmitted, via the transceiver, in a slot in which a downlink transmission (e.g., an SSB, a DL grant, or a channel state information (CSI) reference signal (CSI-RS)) is scheduled.

At 604, the method 600 may include identifying a potential synchronization error when the uplink transmission overlaps, in time and in the slot, any of: a set of one or more symbols in which the downlink transmission is scheduled; X symbols before the set of one or more symbols in which the downlink transmission is scheduled; or Y symbols after the set of one or more symbols in which the downlink transmission is scheduled.

At 606, the method 600 may include dropping the uplink transmission upon identifying the potential synchronization error. Otherwise, at 608, the method 600 may include multiplexing transmission of the uplink transmission with reception of the downlink transmission in the slot.

At 610, and as an alternative to the operations at 604, 606, and 608, the method 600 may include dropping the uplink transmission in response to the slot containing the downlink transmission. At 610, the uplink transmission may be dropped regardless of whether the uplink transmission overlaps the set of one or more symbols in which the downlink transmission is scheduled, the X symbols before the set of one or more symbols in which the downlink transmission is scheduled, or the Y symbols after the set of one or more symbols in which the downlink transmission is scheduled.

In some embodiments of the method 600, the uplink transmission may be a PUSCH repetition of a PUSCH with repetition, and the downlink transmission may be an SSB. In some of these embodiments, the method 600 may include operating the UE in a multi-TRP mode when transmitting the PUSCH repetition; and determining, before identifying the potential synchronization error, that a first TRP and a second TRP included in the multi-TRP mode are unsynchronized. In others of these embodiments, the method 600 may include operating the UE to perform an inter-cell mobility operation when transmitting the PUSCH repetition; and determining, before identifying the potential synchronization error, that a first cell and a second cell included in the inter-cell mobility operation are unsynchronized.

When the uplink transmission is a PUSCH repetition and the downlink transmission is an SSB, the SSB may be an SSB transmitted from a serving cell of the UE; an SSB transmitted from a neighbor cell associated with an active TCI state of the UE; or an SSB used for one or more of L1-RSRP measurement, L1-SINR measurement, BFD, CBD, RLM, or pathloss measurement.

In some cases, the method 600 may only be applied to scenarios in which the UL and DL transmissions are associated with different TRPs and/or cells. In other cases, the method 600 may also be applied to scenarios in which the UL and DL transmissions are associated with the same TRP and/or cell.

In some embodiments of the method 600, X and Y may be predefined. For example, X and Y may be based on a minimum required synchronization error between TRPs/cells, as well as the maximum value of timing advance (TA) difference and a minimum transmit/receive or receive/transmit switching delay. In some cases, X and Y may be determined by the minimum or maximum subcarrier spacing of a DL or UL active bandwidth part (BWP).

In some embodiments, the method 600 may include transmitting a UE capability including a value of X and a value of Y.

In some embodiments, X and Y may be based on a system frame number (SFN) and frame timing difference (SFTD) for a first TRP and a second TRP included in a multi-TRP mode of the UE, in combination with a minimum transmit/receive or receive/transmit switching delay. In some embodiments, X and Y may be based on an SFTD for a first cell and a second cell used in an inter-cell mobility operation of the UE, in combination with a minimum transmit/receive or receive/transmit switching delay. In each of these embodiments, the method 600 may include transmitting an SFTD to a base station, so that the base station can determine values of X and Y using the SFTD.

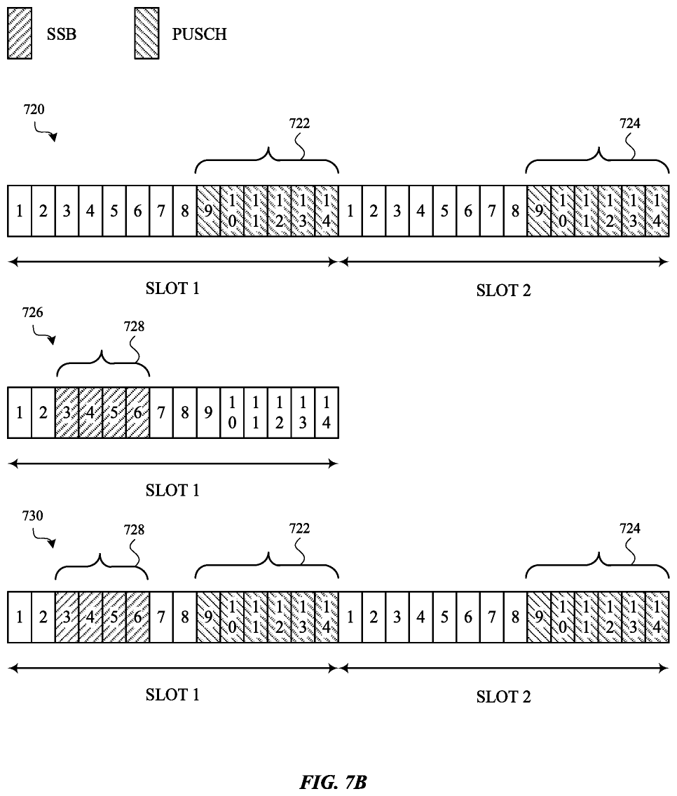

FIG. 7A shows an example of PUSCH repetition dropping, in accord with the operations at 602-606 of method 600, and FIG. 7B shows an example of PUSCH repetition multiplexing, in accord with the operations at 602-604 and 608 of method 600. In the examples shown in FIGS. 7A and 7B, Slot 1 is a flexible slot, and Slot 2 is an UL slot.

In the example of FIG. 7A, a UE may intend to transmit a first PUSCH repetition 702 across symbols 8-14 of Slot 1, and transmit a second PUSCH repetition 704 across symbols 8-14 of Slot 2, as shown in timeline 700. However, a base station may schedule an SSB transmission 708 during symbols 3-6 of Slot 1, as shown in timeline 706. If X=Y=2, the UE may determine that, even though the first PUSCH repetition 702 does not overlap the SSB transmission 708 in time, the first PUSCH repetition 702 does overlap one of the symbols that is within Y=2 symbols of the SSB transmission 708. As a result, the UE may drop the first PUSCH repetition 702 and only transmit the second PUSCH repetition 704, as shown in timeline 710.

In the example of FIG. 7B, a UE may intend to transmit a first PUSCH repetition 722 across symbols 9-14 of Slot 1, and transmit a second PUSCH repetition 724 across symbols 9-14 of Slot 2, as shown in timeline 720. However, a base station may schedule an SSB transmission 728 during symbols 3-6 of Slot 1, as shown in timeline 726. If X=Y=2, then because the first PUSCH repetition 722 does not overlap the SSB transmission 728, and begins at least two symbols after the SSB transmission 728, the UE may multiplex transmission of the first PUSCH repetition 722 with the SSB transmission 728 in Slot 1, and may also transmit the second PUSCH repetition 724 in Slot 2, as shown in timeline 730.

When X and Y are based on an SFTD, an SFN offset can be calculated for the SFTD as:

$$SFN offset = SFN\_TRP 1 - SFN\_TRP 2 ,$$

where TRP1 and TRP2 are first and second TRPs, and SFN_TRP1 and SFN_TRP2 are respective SFNs for the first and second TRPs. X and Y may alternatively be calculated as:

$$SFN offset = SFN\_servingCell - SFN\_neighborCell ,$$

where SFN_servingCell and SFN_neighborCell are respective SFNs for respective serving and neighbor cells.

A frame boundary offset (FBO) can be calculated for the SFTD as:

$$T\_TRP 1 - T\_TRP 2 ; or$$

$$Floor ( ( T\_TRP 1 - T\_TRP 2 ) / 5 )$$

where T_x indicates the time of receipt of the first radio frame from TRP x. Alternatively, an FBO can be calculated as:

$$T\_servingCell - T\_neighborCell ; or \\ Floor ( T\_servingCell - T\_neighborCell ) / 5 )$$

where T_x indicates the time of receipt of the first radio frame from Cell x.

In some cases, the SFN offset may not be included in an SFTD report, if the SFN can be assumed to be the same for the TRPs/cells on which the SFTD report is based.

The UE may transmit an SFTD report, to a base station, using higher layer signaling. The higher layer signaling may include RRC signaling, a MAC CE, or uplink control information (UCI) carried on a PUSCH or physical uplink control channel (PUCCH).

In some cases, a UE may be associated with N assistant TRPs or neighbor cells, where N is greater than one (N>1). In these cases, the UE may be configured (e.g., by a base station) to transmit an SFTD report (or reports) based on a subset of one or more TRPs/cells in a multi-TRP mode, where the subset of one or more TRPs/cells are configured (or indicated) by higher layer signaling (e.g., in RRC signaling or a MAC CE). Alternatively, a UE may be configured (by a base station or by default) to transmit an SFTD report (or reports) based on all configured TRP/cells in a multi-TRP mode. As another alternative, a UE may be configured (by a base station or by default), to transmit an SFTD report (or reports) for all active TRPs/cells in a multi-TRP mode. In the latter case, active TRPs/cells can be considered to be the TRPs/cells associated with an active TCI state and/or an SSB used for one or more of L1-RSRP measurement, L1-SINR measurement, BFD, CBD, RLM, or pathloss measurement.

When X and Y are based on an SFTD, the values of X and Y may in some cases be determined (e.g., by a base station) based on a reported FBO and a minimum transmit/receive or receive/transmit switching delay. For example, X and Y may be determined as:

$$X = Y = min \{ 1 , abs ( ceil ( FBO / N ) ) \} + d\_tx \_rx$$

where abs is an absolute value function, ceil is a ceiling function, N is a number of time samples per symbol, and d_tx_rx is the minimum transmit/receive or receive/transmit switching delay.

As another example, when X and Y are based on an SFTD, the values of X and Y may in some cases be determined (e.g., by a base station) based on the identities of the associated TRP or cell for the UL transmission and DL transmission (or in the case of a PUSCH repetition and an SSB, the identities of the associated TRP or cell for the UL channel carrying the PUSCH repetition and the TRP or cell transmitting the SSB). In one example:
If FBO>0,

If the UL transmission is associated with a serving cell for the UE and the SSB is associated with a neighbor cell for the UE,

$$Then X = min \{ 1 , abs ( ceil ( FBO / N ) ) \} ,$$

If the UL transmission is associated with the neighbor cell for the UE and the SSB is associated with the serving cell for the UE,

$$Then X = 1 , Y = min \{ 1 , abs ( ceil ( FBO / N ) ) \} ;$$

If FBO<0

If the UL transmission is associated with the serving cell for the UE and the SSB is associated with the neighbor cell for the UE,

$$Then X = 1 , Y = min \{ 1 , ceil ( FBO / N ) \} ; \qquad$$

If the UL transmission is associated with the neighbor cell for the UE and the SSB is associated with the serving cell for the UE,

$$Then X = min \{ 1 , ceil ( FBO / N ) \} ,$$

If the UL transmission and the SSB are both associated with the serving cell,

$$Then X = Y = 1 .$$

The above example assumes that the values of X and Y are in symbols, and that any values are rounded up to the next greater integer number of symbols. The above example also assumes that d_tx_rx=1 symbol.

Although the method described with reference to FIG. 6 is described in terms of dropping or multiplexing an UL transmission with respect to a DL transmission, a base station could alternatively expect a UE to not receive on a configured DL grant and/or measured a configured CSI-RS when such a transmission overlaps, in time, a dynamic UL transmission. For purposes of determining “overlap,” X symbols before the DL grant and Y symbols after the DL grant may be considered to be part of the DL transmission.

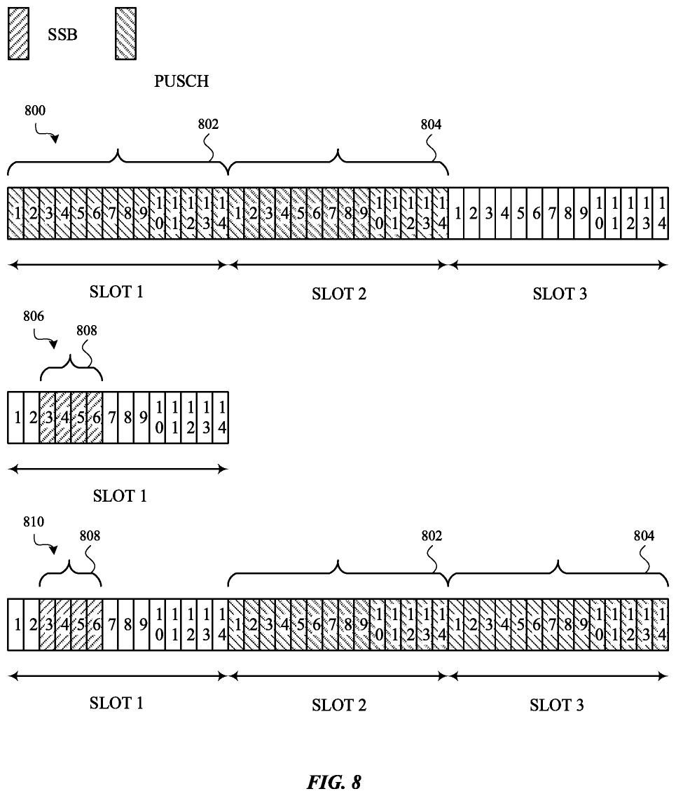

As an alternative to the dropping or multiplexing described with reference to FIGS. 6, 7A, and 7B, a flexible slot in which a DL transmission is scheduled may be considered “not available” for UL transmission, and UL resource mapping may resume from the next available slot. An example of this is shown in FIG. 8. As shown in FIG. 8, a UE may intend to transmit a first PUSCH repetition 802 across all symbols of Slot 1, and transmit a second PUSCH repetition 804 across all symbols of Slot 2, as shown in timeline 800. However, a base station may schedule an SSB transmission 808 during symbols 3-6 of Slot 1, as shown in timeline 806. Because the SSB transmission 808 is scheduled in Slot 1, the UE may consider Slot 1 to be unavailable for UL transmission and move transmission of the first PUSCH repetition 802 to Slot 2. The second PUSCH repetition 804 may be moved to Slot 3, following Slot 2, as shown in timeline 810. In this manner, there is no dropping or multiplexing of UL transmissions.

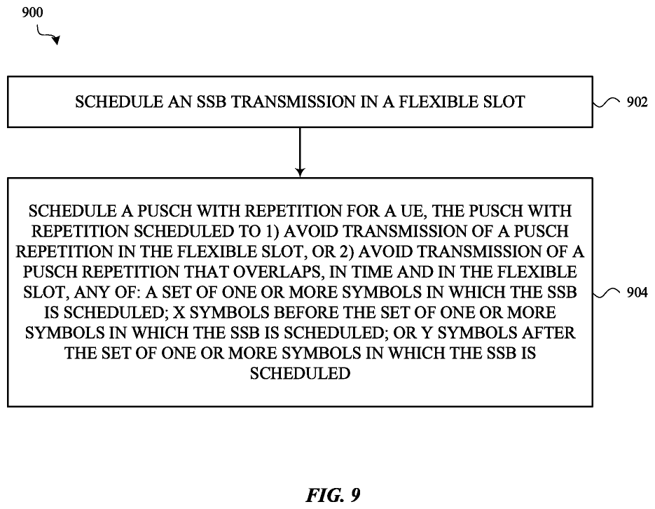

FIG. 9 shows an example method 900 of wireless communication by a base station (e.g., a gNB or eNB), which method 900 may be used to perform UL resource mapping that, for multi-TRP and/or inter-cell mobility operation of the UE, accounts for synchronization errors between TRPs/cells. The method 900 may be performed by a processor of the UE, and transmissions and receptions initiated by the processor may be made using a transceiver of the UE.

At 902, the method 900 may include scheduling an SSB transmission (or other DL transmission) in a flexible slot.

At 904, the method 900 may include scheduling a PUSCH with repetition (or other UL transmission) for a UE. The PUSCH with repetition may be scheduled to 1) avoid transmission of a PUSCH repetition (or other UL transmission) in the flexible slot, or 2) avoid transmission of a PUSCH repetition (or other UL transmission) that overlaps, in time and in the slot, any of: a set of one or more symbols in which the SSB (or other DL transmission) is scheduled; X symbols before the set of one or more symbols in which the SSB (or other DL transmission) is scheduled; or Y symbols after the set of one or more symbols in which the SSB (or other DL transmission) is scheduled.

Optionally, the method 900 may include receiving, from the UE, at least one PUSCH repetition of the PUSCH with repetition (or the other UL transmission).

The method 900 provides scheduling restrictions that avoid UL/DL scheduling conflicts within a flexible slot.

Embodiments contemplated herein include an apparatus having means to perform one or more elements of the method 500, 600, and 900. In the context of method 500 or 600, this apparatus may be, for example, an apparatus of a UE (such as a wireless device 1102 that is a IIF, as described herein). In the context of method 900, this apparatus may be, for example, an apparatus of a base station (such as a network device 1120 that is a base station, as described herein).

Embodiments contemplated herein include one or more non-transitory computer-readable media storing instructions to cause an electronic device, upon execution of the instructions by one or more processors of the electronic device, to perform one or more elements of the method 500, 600, or 900. In the context of method 500 or 600, this non-transitory computer-readable media may be, for example, a memory of a UE (such as a memory 1106 of a wireless device 1102 that is a UE, as described herein). In the context of method 900, this non-transitory computer-readable media may be, for example, a memory of a base station (such as a memory 1124 of a network device 1120 that is a base station, as described herein).

Embodiments contemplated herein include an apparatus having logic, modules, or circuitry to perform one or more elements of the method 500, 600, or 900. In the context of method 500 or 600, this apparatus may be, for example, an apparatus of a UE (such as a wireless device 1102 that is a UE, as described herein). In the context of method 900, this apparatus may be, for example, an apparatus of a base station (such as a network device 1120 that is a base station, as described herein).

Embodiments contemplated herein include an apparatus having one or more processors and one or more computer-readable media, using or storing instructions that, when executed by the one or more processors, cause the one or more processors to perform one or more elements of the method 500, 600, or 900. In the context of method 500 or 600, this apparatus may be, for example, an apparatus of a UE (such as a wireless device 1102 that is a UE, as described herein). In the context of the method 900, this apparatus may be, for example, an apparatus of a base station (such as a network device 1120 that is a base station, as described herein).

Embodiments contemplated herein include a signal as described in or related to one or more elements of the method 500, 600, or 900.

Embodiments contemplated herein include a computer program or computer program product having instructions, wherein execution of the program by a processor causes the processor to carry out one or more elements of the method 500, 600, or 900. In the context of method 500 or 600, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). In the context of method 900, the processor may be a processor of a base station (such as a processor(s) 1122 of a network device 1120 that is a base station, as described herein), and the instructions may be, for example, located in the processor and/or on a memory of the base station (such as a memory 1124 of a network device 1120 that is a base station, as described herein).

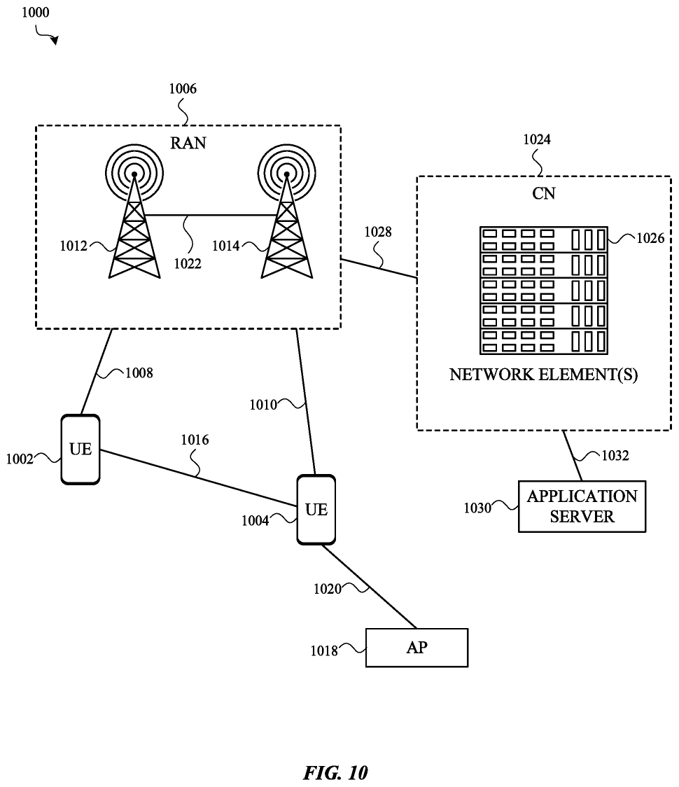

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

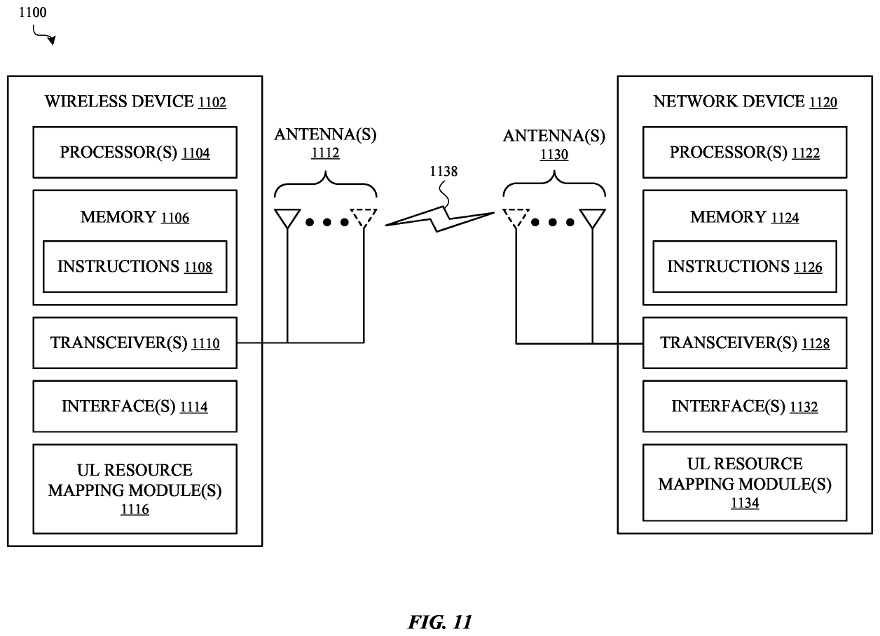

FIG. 11 illustrates a system 1100 for performing signaling 1138 between a wireless device 1102 and a network device 1120, according to embodiments disclosed herein. The system 1100 may be a portion of a wireless communications system as herein described. The wireless device 1102 may be, for example, a UE of a wireless communication system. The network device 1120 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1138) to and/or from the wireless device 1102 with other devices (e.g., the network device 1120) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a UL resource mapping module 1116. The UL resource mapping module 1116 may be implemented via hardware, software, or combinations thereof. For example, the UL resource mapping module 1116 may be implemented as a processor, circuit, and/or instructions 1108 stored in the memory 1106 and executed by the processor(s) 1104. In some examples, the UL resource mapping module 1116 may be integrated within the processor(s) 1104 and/or the transceiver(s) 1110. For example, the UL resource mapping module 1116 may be implemented by a combination of software components (e.g., executed by a DSP or a general processor) and hardware components (e.g., logic gates and circuitry) within the processor(s) 1104 or the transceiver(s) 1110.

The UL resource mapping module 1116 may be used for various aspects of the present disclosure, for example, aspects of FIGS. 1-9. The UL resource mapping module 1116 may be configured to, for example, map a PUSCH with repetition and/or CSI to particular UL resources, and/or resolve UL/DL transmission conflicts.

The network device 1120 may include one or more processor(s) 1122. The processor(s) 1122 may execute instructions such that various operations of the network device 1120 are performed, as described herein. The processor(s) 1122 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 that may include RF transmitter and/or receiver circuitry that use the antenna(s) 1130 of the network device 1120 to facilitate signaling (e.g., the signaling 1138) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 that is a base station may include interface(s) 1132 made up of transmitters, receivers, and other circuitry (e.g., other than the transceiver(s) 1128/antenna(s) 1130 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1120 may include an UL resource mapping module 1134. The UL resource mapping module 1134 may be implemented via hardware, software, or combinations thereof. For example, the UL resource mapping module 1134 may be implemented as a processor, circuit, and/or instructions 1126 stored in the memory 1124 and executed by the processor(s) 1122. In some examples, the UL resource mapping module 1134 may be integrated within the processor(s) 1122 and/or the transceiver(s) 1128. For example, the UL resource mapping module 1134 may be implemented by a combination of software components (e.g., executed by a DSP or a general processor) and hardware components (e.g., logic gates and circuitry) within the processor(s) 1122 or the transceiver(s) 1128.

The UL resource mapping module 1134 may be used for various aspects of the present disclosure, for example, aspects of FIGS. 1-9. The UL resource mapping module 1134 may be used, for example, to configure a UE (e.g., the wireless device 1102) to map a PUSCH with repetition and/or CSI to particular UL resources, and/or to configure a UE to resolve UL/DL transmission conflicts.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
determine an uplink transmission is intended to be transmitted, via the transceiver, in a slot in which a downlink transmission is scheduled;
identify a potential synchronization error when the uplink transmission overlaps, in time and in the slot, any of,
a set of one or more symbols in which the downlink transmission is scheduled;
X symbols before the set of one or more symbols in which the downlink transmission is scheduled; or
Y symbols after the set of one or more symbols in which the downlink transmission is scheduled; and
drop the uplink transmission upon identifying the potential synchronization error, and otherwise multiplex transmission of the uplink transmission with reception of the downlink transmission in the slot.

2. The UE of claim 1, wherein X and Y are predefined.

3. The UE of claim 1, wherein the processor is configured to transmit, via the transceiver, a UE capability including a value of X and a value of Y.

4. The UE of claim 1, wherein X and Y are based on:
a system frame number (SFN) and frame timing difference (SFTD) for a first transmission and reception point (TRP) and a second TRP included in a multi-TRP mode of the UE; and
a minimum transmit/receive or receive/transmit switching delay.

5. The UE of claim 4, wherein:
the multi-TRP mode includes two or more assistant TRPs; and
the processor is configured to transmit an SFTD based on a subset of TRPs in the multi-TRP mode.

6. The UE of claim 4, wherein:
the multi-TRP mode includes two or more assistant TRPs; and
the processor is configured to transmit an SFTD based on all TRPs in the multi-TRP mode.

7. The UE of claim 4, wherein:
the multi-TRP mode includes two or more assistant TRPs; and
the processor is configured to transmit an SFTD based on all active TRPs in the multi-TRP mode.

8. The UE of claim 4, wherein:
the system frame number (SFN) is assumed to be the same for the first TRP and the second TRP; and
the SFTD includes a frame boundary offset (FBO) but not an SFN offset.

9. The UE of claim 4, wherein:
one of X or Y is equal to 1; and
the other of X or Y is equal to a minimum of,
1; or
an absolute value of a ceiling function of FBO/N, where FBO is a frame boundary offset, and N is a number of time samples per symbol.

10. The UE of claim 1, wherein X and Y are based on:
a system frame number (SFN) and frame timing difference (SFTD) for a first cell and a second cell included in an inter-cell mobility operation of the UE; and
a minimum transmit/receive or receive/transmit switching delay.

11. The UE of claim 1, wherein:
the uplink transmission is a physical uplink shared channel (PUSCH) repetition of a PUSCH with repetition; and
the downlink transmission is a synchronization signal block (SSB).

12. The UE of claim 11, wherein:
the processor is configured to,
operate the UE in a multiple transmission and reception point (multi-TRP) mode when transmitting the PUSCH repetition; and
determine, before identifying the potential synchronization error, that a first TRP and a second TRP included in the multi-TRP mode are unsynchronized.

13. The UE of claim 11, wherein the SSB is at least one of:
transmitted from a serving cell of the UE;
transmitted from a neighbor cell associated with an active transmission configuration indicator (TCI) state of the UE; or
used for one or more of Layer 1 (L1) reference signal received power (RSRP) (L1-RSRP) measurement, L1 signal to interference noise ratio (L1-SINR) measurement, beam failure detection (BFD), candidate beam detection (CBD), radio link monitoring (RLM), or pathloss measurement.

14. A base station, comprising:
a transceiver; and
a processor configured to,
schedule a synchronization signal block (SSB) transmission in a flexible slot; and
schedule a physical uplink shared channel (PUSCH) with repetition for a user equipment (UE), the PUSCH with repetition scheduled to
avoid transmission of a PUSCH repetition in the flexible slot; or
avoid transmission of a PUSCH repetition that overlaps, in time and in the flexible slot, any of,
a set of one or more symbols in which the SSB is scheduled;
X symbols before the set of one or more symbols in which the SSB is scheduled; or
Y symbols after the set of one or more symbols in which the SSB is scheduled.

15. The base station of claim 14, wherein the processor is configured to receive, from the UE and via the transceiver, at least one PUSCH repetition of the PUSCH with repetition.

16. A user equipment (UE), comprising:
a transceiver; and
a processor configured to,
receive, via the transceiver, a request to transmit aperiodic channel state information (CSI); and
one of,
determine, for a physical uplink shared channel (PUSCH) with repetition, a same number of phase tracking reference signal (PT-RS) ports are to be used for a first PUSCH repetition transmitted on a first beam and a first PUSCH repetition transmitted on a second beam and, in response to determining the same number of PT-RS ports are to be used for the first PUSCH repetition transmitted on the first beam and the first PUSCH repetition transmitted on the second beam, transmitting a respective repetition of the aperiodic CSI in each of the first PUSCH repetition transmitted on the first beam and the first PUSCH repetition transmitted on the second beam; or
determine, for the PUSCH with repetition, CSI repetition is enabled and, in response to determining the CSI repetition is enabled, transmitting a respective repetition of the aperiodic CSI, with the same number of PT-RS ports, in the first PUSCH repetition transmitted on the first beam and the first PUSCH repetition transmitted on the second beam.

17. The UE of claim 16, wherein the same number of PT-RS ports is zero PT-RS ports.

18. The UE of claim 16, wherein:
the processor is configured to,
determine, for the PUSCH with repetition, the CSI repetition is enabled and, in response to determining the CSI repetition is enabled, transmitting the aperiodic CSI with the same number of PT-RS ports in the first PUSCH repetition transmitted using the first beam and in the first PUSCH repetition transmitted using the second beam;
identify the same number of PT-RS ports as a first number of PT-RS ports to be used in the first PUSCH repetition transmitted using the first beam; and
harmonize, with the first number of PT-RS ports, a second number of PT-RS ports to be used in the first PUSCH repetition transmitted using the second beam.

19. The UE of claim 16, wherein:
the processor is configured to,
determine, for the PUSCH with repetition, the CSI repetition is enabled and, in response to determining the CSI repetition is enabled, transmitting the aperiodic CSI with the same number of PT-RS ports in the first PUSCH repetition transmitted using the first beam and in the first PUSCH repetition transmitted using the second beam; and
determine the same number of PT-RS ports based on a first initial number of PT-RS ports to be used in the first PUSCH repetition transmitted using the first beam and a second initial number of PT-RS ports to be used in the first PUSCH repetition transmitted using the second beam.

20. The UE of claim 19, wherein the same number of PT-RS ports is a maximum or a minimum of:
the first initial number of PT-RS ports to be used in the first PUSCH repetition transmitted using the first beam; and
the second initial number of PT-RS ports to be used in the first PUSCH repetition transmitted using the second beam.
